(19) United States
(12) Patent Application Publication
(10) Pub. No.: US 2024/0036862 A1
(43) Pub. Date: Feb. 1, 2024

(54) PACKET PROCESSING IN A DISTRIBUTED DIRECTED ACYCLIC GRAPH

(71) Applicant: 3nets.io, Inc., Santa Clara, CA (US)

(72) Inventors: Corneliu-Ilie Calciu, Bucharest (RO); Gavril-Ioan Florian, Chitila (RO)

(21) Appl. No.: 17/878,646

(22) Filed: Aug. 1, 2022

(51) Int. Cl. G06F 9/30; G06F 13/28; G06F 12/0817

(52) U.S. Cl. CPC G06F 9/30036; G06F 13/28; G06F 12/0817

(57) ABSTRACT

A method for transmitting a packet vector across compute nodes implementing a packet processing graph on a vector packet processor is disclosed. The method includes determining that a packet vector processed by a previous graph node in a first compute node is ready to be processed by a next graph node in a second compute node. The packet vector includes a plurality of data packets and the previous and next graph nodes are graph nodes of a packet processing graph implemented as a directed acyclic graph (“DAG”) that extends across the first and second compute nodes. The first and second compute nodes each run an instance of a vector packet processor. The method includes transmitting the packet vector from the first compute node to the second compute node using remote direct memory access (“RDMA”).

### FIELD

The subject matter disclosed herein relates to packet processing and more particularly relates to packet processing between compute nodes for a distributed acyclic graph.

### BACKGROUND

Packet processing has traditionally been done using scalar processing, which includes processing one data packet at a time. Vector packet processing (“VPP”) uses vector processing which is able to process more than one data packet at a time. VPP is often implemented in data centers using generic compute nodes. In some instances, a packet processing graph extends across more than one compute node so that data packets must be transmitted from a first compute node to a second compute node. Traditional transmission of packets between compute nodes may become a bottleneck.

### BRIEF SUMMARY

A method for transmitting a packet vector across compute nodes implementing a packet processing graph on a vector packet processor is disclosed. The method includes determining that a packet vector processed by a previous graph node in a first compute node is ready to be processed by a next graph node in a second compute node. The packet vector includes a plurality of data packets and the previous and next graph nodes are graph nodes of a packet processing graph implemented as a directed acyclic graph (“DAG”) that extends across the first and second compute nodes. The first and second compute nodes each run an instance of a vector packet processor. The method includes transmitting the packet vector from the first compute node to the second compute node using remote direct memory access (“RDMA”).

An apparatus for transmitting a packet vector across compute nodes implementing a packet processing graph on a vector packet processor includes a first compute node with a first processor running an instance of a vector packet processor. The first compute node is connected to a second compute node over a network and the second compute node includes a second processor running another instance of the vector packet processor. The apparatus includes non-transitory computer readable storage media storing code. The code is executable by the first processor to perform operations that include determining that a packet vector processed by a previous graph node in the first compute node is ready to be processed by a next graph node in the second compute node. The packet vector includes a plurality of data packets and the previous and next graph nodes are graph nodes of a packet processing graph implemented as a DAG that extends across the first and second compute nodes. The apparatus includes transmitting the packet vector from the first compute node to the second compute node using RDMA.

A program product for transmitting a packet vector across compute nodes implementing a packet processing graph on a vector packet processor includes a non-transitory computer readable storage medium storing code. The code is configured to be executable by a processor to perform operations that include determining that a packet vector processed by a previous graph node in a first compute node is ready to be processed by a next graph node in a second compute node. The packet vector includes a plurality of data packets and the previous and next graph nodes are graph nodes of a packet processing graph implemented as a DAG that extends across the first and second compute nodes. The first and second compute nodes are each running an instance of a vector packet processor. The operations include transmitting the packet vector from the first compute node to the second compute node using RDMA.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating a system for transferring data between compute nodes running a distributed packet processing graph, according to various embodiments;

FIG. 2 is a schematic block diagram illustrating a partial system for transferring data between compute nodes running a distributed packet processing graph showing process flow, according to various embodiments;

FIG. 3 is a schematic block diagram illustrating a partial system for transferring data between compute nodes running a distributed packet processing graph showing components of the compute nodes, according to various embodiments;

FIG. 4 is a schematic block diagram illustrating an apparatus for transferring data between compute nodes running a distributed packet processing graph. according to various embodiments;

FIG. 5 is a schematic block diagram illustrating another apparatus for transferring data between compute nodes running a distributed packet processing graph. according to various embodiments;

FIG. 6 is a schematic flow chart diagram illustrating a method for transferring data between compute nodes running a distributed packet processing graph, according to various embodiments; and

FIG. 7 is a schematic flow chart diagram illustrating another method for transferring data between compute nodes running a distributed packet processing graph, according to various embodiments.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

More specific examples (a non-exhaustive list) of the storage device would include the following: an electrical connection having one or more wires, a portable computer diskette, a hard disk, a random access memory (“RAM”), a read-only memory (“ROM”), an crasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example. two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

A method for transmitting a packet vector across compute nodes implementing a packet processing graph on a vector packet processor is disclosed. The method includes determining that a packet vector processed by a previous graph node in a first compute node is ready to be processed by a next graph node in a second compute node. The packet vector includes a plurality of data packets and the previous and next graph nodes are graph nodes of a packet processing graph implemented as a directed acyclic graph (“DAG”) that extends across the first and second compute nodes. The first and second compute nodes each run an instance of a vector packet processor. The method includes transmitting the packet vector from the first compute node to the second compute node using remote direct memory access (“RDMA”).

In some embodiments, the packet vector includes metadata and the metadata is transferred to the second compute node along with data of the packet vector. In other embodiments, the packet vector is transmitted from memory of the first compute node to memory of the second compute node. In other embodiments, the memory of the second compute node is level three cache. In other embodiments, the method includes, prior to transmitting the packet vector, communicating with the second compute node to determine a location for transfer of the packet vector to the second compute node. In other embodiments, the first compute node includes a RDMA controller and transmitting the packet vector is via the RDMA controller.

In some embodiments, graph nodes of the packet processing graph in the first compute node are implemented in a first VM and graph nodes of the packet processing graph in the second compute node are implemented in a second VM. In other embodiments, the packet processing graph is a virtual router and/or a virtual switch. In other embodiments, the first and second compute nodes are generic servers in a datacenter.

An apparatus for transmitting a packet vector across compute nodes implementing a packet processing graph on a vector packet processor includes a first compute node with a first processor running an instance of a vector packet processor. The first compute node is connected to a second compute node over a network and the second compute node includes a second processor running another instance of the vector packet processor. The apparatus includes non-transitory computer readable storage media storing code. The code is executable by the first processor to perform operations that include determining that a packet vector processed by a previous graph node in the first compute node is ready to be processed by a next graph node in the second compute node. The packet vector includes a plurality of data packets and the previous and next graph nodes are graph nodes of a packet processing graph implemented as a DAG that extends across the first and second compute nodes. The apparatus includes transmitting the packet vector from the first compute node to the second compute node using RDMA.

In some embodiments, the packet vector includes metadata and the metadata is transferred to the second compute node along with data of the packet vector. In other embodiments, the packet vector is transmitted from memory of the first compute node to memory of the second compute node. In other embodiments, the memory of the second compute node is level three cache. In other embodiments, the operations include, prior to transmitting the packet vector, communicating with the second compute node to determine a location for transfer of the packet vector to the second compute node. In other embodiments, the first compute node includes a RDMA controller and transmitting the packet vector is via the RDMA controller.

In some embodiments, graph nodes of the packet processing graph in the first compute node are implemented in a first VM and graph nodes of the packet processing graph in the second compute node are implemented in a second VM. In other embodiments, the packet processing graph is a virtual router and/or a virtual switch. In other embodiments, the first and second compute nodes include generic servers in a datacenter.

A program product for transmitting a packet vector across compute nodes implementing a packet processing graph on a vector packet processor includes a non-transitory computer readable storage medium storing code. The code is configured to be executable by a processor to perform operations that include determining that a packet vector processed by a previous graph node in a first compute node is ready to be processed by a next graph node in a second compute node. The packet vector includes a plurality of data packets and the previous and next graph nodes are graph nodes of a packet processing graph implemented as a DAG that extends across the first and second compute nodes. The first and second compute nodes are each running an instance of a vector packet processor. The operations include transmitting the packet vector from the first compute node to the second compute node using RDMA.

In some embodiments, the packet vector is transmitted from memory of the first compute node to level three cache of the second compute node.

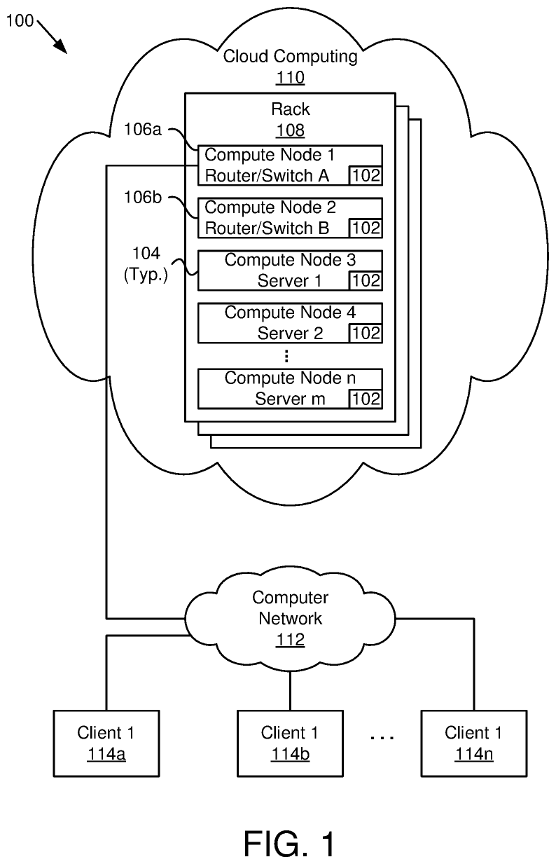

FIG. 1 is a schematic block diagram illustrating a system 100 for transferring data between compute nodes 104, 106, running a distributed packet processing graph, according to various embodiments. The system 100 is for a cloud computing environment where compute nodes 104, 106 are in a datacenter. In other embodiments, the compute nodes 104. 106 are in a customer data center, an edge computing site, or the like.

Each compute node 104, 106 includes a transfer apparatus 102 configured to transfer a packet vector across compute nodes 104 or 106 using remote direct memory access (“RDMA”), which provides advantages over existing technologies where packets from a packet vector are sent one-by-one from one compute node (e.g., compute node 1 106a) to another compute node (e.g., compute node 2 106b). In some embodiments, at least some of the compute nodes 104, 106 run a vector packet processor. Vector packet processing (“VPP”) is implemented using a vector packet processor.

A vector packet processor executes a packet processing graph, which is a modular approach that allows plugin graph nodes. In some embodiments, the graph nodes are arranged in a directed acyclic graph (“DAG”). A DAG is a directed graph with no directed cycles. A DAG includes vertices (e.g., typically circles, also called nodes) and edges, which are represented as lines or arcs with an arrow. Each edge is directed from one vertex to another vertex and following the edges and vertices does not form a closed loop. In the packet processing graph, vertices are graph nodes and each represent a process step where some function is performed on packets of each packet vector. Packet vectors are formed at a beginning of the packet processing graph from sequentially received packets that are grouped into a packet vector.

VPP uses vector processing instead of scalar processing, which refers to processing one packet at a time. Scalar processing often causes threshing in instruction cache (“I-cache”), each packet incurring an identical set of I-cache misses, and no workaround to the above problems except larger caches. VPP processes more than one packet at a time, which solves I-cache thrashing, fixes issues associated with data cache (“D-cache) mises on stack addresses, improves circuit time, and other benefits.

A desirable feature of the vector packet processor is the case in which plugin graph nodes are added, removed, and modified, which can often be done without rebooting the compute node 104, 106 running the vector packet processor. A plugin is able to introduce a new graph node or rearrange a packet processing graph. In addition, a plugin may be built independently of a VPP source tree and may be installed by adding the plugin to a plugin directory.

The vector packet processor is typically able to run on generic compute nodes, which are often found in datacenters. Packet processing graphs provide a capability of emulating a wide variety of hardware devices and software processes. For example, a vector packet processor is able to create a virtual router, a virtual switch, or a combination virtual router/switch. Thus, a switch and/or router may be implemented with one or more generic compute nodes. In other embodiments, a vector packet processor is used to implement a Virtual Extensible Local Area Network (“VXLAN”), implementation of Internet Protocol Security (“IPsec”), Dynamic Host Configuration Protocol (“DHCP”) proxy client support, neighbor discovery, Virtual Local Area Network (“VLAN”) support, and may other functions. In some embodiments, a vector packet processor running all or a portion of a packet processing graph runs on a virtual machine (“VM”) running on a compute node 104, 106. In other embodiments, all or a portion of a packet processing graph runs on a compute node 104, 106 that is a bare metal server.

Some packet processing graphs, however, are too big to be executed by a single compute node 104, 106 and must be spread over two or more compute nodes 104, 106. Often, metadata generated by various graph nodes and parts of the packet processing graph is included with each packet vector. However, currently when a packet vector reaches the last graph node on a compute node (e.g., compute node 1 106a), the packet vector is transmitted to the next compute node (e.g., compute node 2 106b) packet-by-packet and the metadata is lost.

The transfer apparatus 102 provides a unique solution where a packet vector is transmitted from one compute node 106a to another compute node 106b using Remote Direct Memory Access (“RDMA”). Using RDMA to transfer a packet vector allows metadata to be transferred with the packet vector. In addition, the transfer apparatus 102 provides a transfer solution that is faster than the current solutions. The transfer apparatus 102 is explained in more detail below.

The system 100 depicts a transfer apparatus 102 in each compute node 104, 106 installed in various racks 108. The racks 108 of compute nodes 104, 106 are depicted as part of a cloud computing environment 110. In other embodiments, the racks 108 of compute nodes 104, 106 are part of a datacenter, which is not a cloud computing environment 110, but may be a customer datacenter or other solution with compute nodes 104, 106 executing a packet processing graph with a vector packet processor.

Where the compute nodes 104, 106 are part of a cloud computing environment 110, one or more clients 114a, 114b, . .. 114n (generically or collectively “114”) are connected to the compute nodes 104, 106 over a computer network 112. The clients 114 are computing devices and in some embodiments, allow users to run workloads, applications, etc. on the compute nodes 104, 106. In various embodiments, the clients 114 may be implemented on a server, a desktop computer, laptop computer, a tablet computer, a smartphone, a workstation, a mainframe computer, or other computing device capable of initiating workloads, applications, etc. on the compute nodes 104, 106.

The computer network 112, in various embodiments, include one or more computer networks. In some embodiments, the computer network 112 includes a LAN, a WAN, a fiber network, the internet, a wireless connection, and the like. The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (“ASTM”®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The compute nodes 104, 106 are depicted in racks 108, but may also be implemented in other forms, such as in desktop computers, workstations, an edge computing solution, etc. The compute nodes 104, 106 are depicted in two forms: a compute node 106a, 106b configured as a virtual switch/router, and compute nodes 104 that are servers. The compute nodes/servers 104 are intended to run workloads while the compute nodes/switches 106 run vector packet processors and are configured to run a packet processing graph emulating a virtual router/switch. In other embodiments, the racks 108 include hardware routers/switches instead of virtual routers/switches.

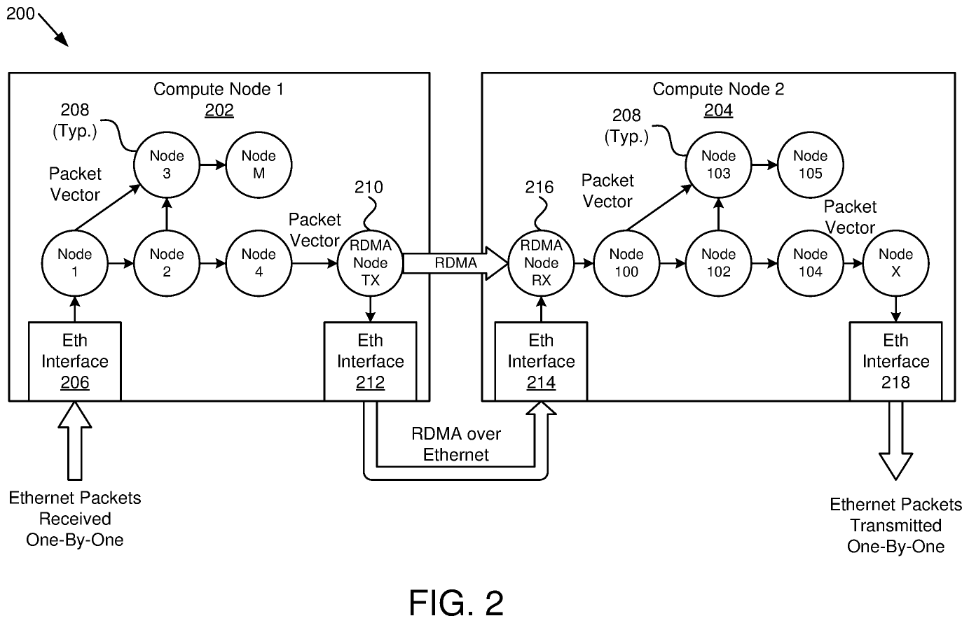

FIG. 2 is a schematic block diagram illustrating a partial system 200 for transferring data between compute nodes 202, 204 running a distributed packet processing graph showing process flow, according to various embodiments. In some embodiments, the compute nodes 202, 204 of FIG. 2 are substantially similar to the compute nodes 104, 106 of FIG. 1. Each compute node 202, 204 includes graph nodes 208 arranged in a DAG. The graph nodes 208 are intended to depict a packet processing graph that extends across from the first compute node 202 to the second compute node 204.

In the partial system 200 of FIG. 2, ethernet packets are received one-by-one at an ethernet interface 206 of the first compute node 202. The packets are assembled into packet vectors that traverse the graph nodes 208 (e.g., node 1, node 2, node 3, node 4, node m) of the first compute node 202. The packet processing graph extends from node 4 to node 100 in the second compute node 204. To facilitate the transfer of packet vectors from the first compute node 202 to the second compute node 204, packet vectors leaving node 4 enter an RDMA transfer node 210 and the packet vectors are transferred to an RDMA receiver node 216 via RDMA. While an RDMA arrow is shown directly between the RDMA transfer node 210 and the RDMA receiver node 216, the RDMA process utilizes ethernet interfaces 212, 214 of the compute nodes 202, 204 and, in some embodiments, the RDMA process is over ethernet.

Once a packet vector reaches the RDMA receiver node 216, the packet vector is transferred to the next graph node 100, and the packet vector then traverses the graph nodes 208 (e.g., node 102, node 103, node 104, node 105, node x). Some packet vectors reach node x, which is a last node in a branch of the packet processing graph, and packets from the packet vectors reaching node x are transmitted again packet-by-packet from an ethernet interface 218. Note that the packet processing graph depicted in FIG. 2 is merely intended to represent a packet processing graph that traverses across compute nodes 202, 204 and one of skill in the art will recognize other actual packet processing graphs where the transfer apparatus 102 is useful to transmit packet vectors from one compute node 202 to another compute node 204.

Note that the partial system 200 of FIG. 2 is intended to show functionality and differs from actual hardware of the compute nodes 202, 204. For example, the ethernet interfaces 206, 212 of the first compute node 202 are typically a single network interface card (“NIC”) in the first compute node 202 and the ethernet interfaces 214, 218 of the second compute node 204 are also a single NIC in the second compute node 204. In addition, the graph nodes 208 are logical constructs meant to represent software code stored in computer readable storage media and executed on processors.

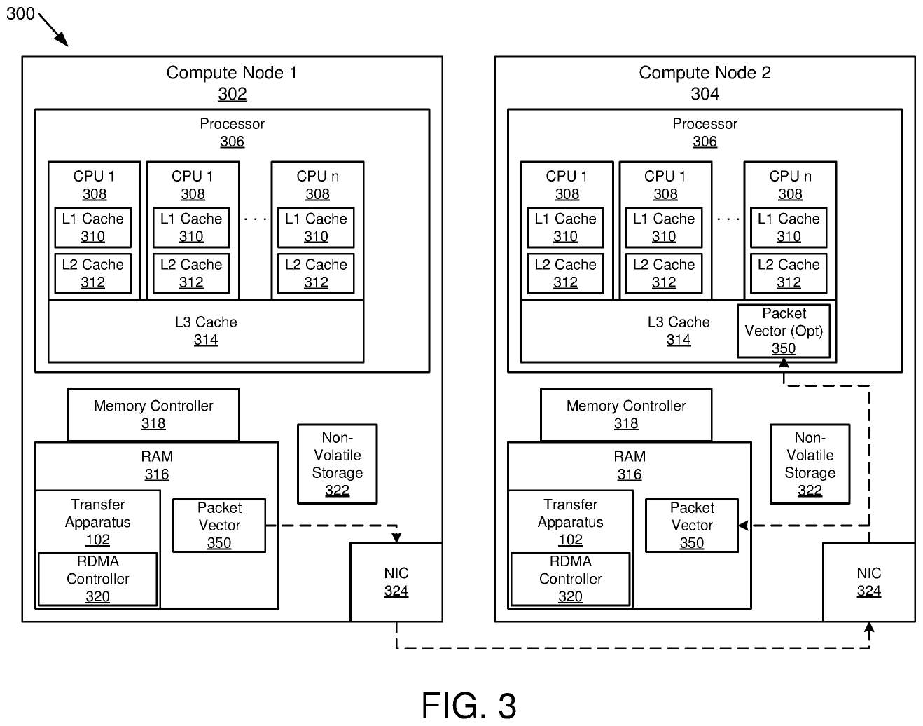

FIG. 3 is a schematic block diagram illustrating a partial system 300 for transferring data between compute nodes running a distributed packet processing graph showing components of the compute nodes 302, 304, according to various embodiments. In some embodiments, the compute nodes 302, 304 of FIG. 3 are substantially similar to the compute nodes 104, 106, 202, 204 of FIGS. 1 and 2. The system 300 includes a processor 306 in each compute node 302, 304 where each processor 306 includes multiple central processing units (“CPUs”) 308. In some embodiments, the CPUs 308 are cores. The CPUs 308 include level 1 cache 310 and level 2 cache 312, which is typically the fasted memory of a computing device and is tightly coupled to the CPUs 308 for speed.

Each compute node 302, 304 also includes level 3 cache 314 shared by the CPUs 308. In addition to the cache 310, 312, 314, each compute node 302, 304 includes random access memory (“RAM”) 316 controlled by a memory controller 318. The RAM 316 is often installed in a slot on a motherboard of the compute nodes 302, 304. Use of level 3 cache 314 is typically faster than use of RAM 316. Each compute node 302, 304 also has access to non-volatile storage 322, which may be internal to the compute nodes 302, 304 as shown, and/or may be external to the compute nodes 302, 304. Each compute node 302, 304 includes a NIC 324 for communications external to the compute nodes 302, 304.

Each of the compute nodes 302, 304 also includes a transfer apparatus 102 that resides in non-volatile storage 322 (not shown), but which is typically loaded into memory, such as RAM 316, during execution. Some of the code of the transfer apparatus 102 may also be loaded into cache 310, 312, 314 as needed. In some embodiments, the transfer apparatus 102 includes an RDMA controller 320, which may be similar to the RDMA transfer node 210 and/or the RDMA receiver node 216 of the partial system 200 of FIG. 2. In other embodiments, the RDMA controllers 320 are separate from the transfer apparatus 102 and are controlled by the transfer apparatus 102.

The RDMA controllers 320 are configured to control transfer of data using RDMA. In some embodiments, the RDMA controller 320 interact with each other in a handshake operation to exchange information, such as a location of data in memory to be transferred, length of the data, a destination location, and the like. The RDMA controllers 320 transfer data through the NIC 324 of a compute node 302, 304.

RDMA is a data transfer method that enables two networked computing devices to exchange data in main memory without relying on the processor 306, cache 310, 312, 314 or the operating system of either computer. Like locally based direct memory access (“DMA”), RDMA improves throughput and performance by freeing up resources, which results in faster data transfer and lower latency between the computing devices, which in this case are compute nodes 302, 304. In some embodiments, RDMA moves data in and out of the compute nodes 302, 304 using a transport protocol in the NIC 324 of the computing devices 302, 304. In some embodiments, the compute nodes 302, 304 are each configured with a NIC 324 that supports RDMA over Converged Ethernet (“ROCE”), which enables the transfer apparatus 102 to carry out RoCE based communications. In other embodiments, the NICs 324 are configured with InfiniBand®. In other embodiments, the NICs 324 are configured with another protocol that enables RDMA.

In some embodiments, the RDMA controllers 320 are configured to transfer data to level 3 cache 314 of the destination compute node 304. Having a packet vector transferred directly to the level 3 cache 314, in some embodiments, enables faster processing than transfer to RAM 316 of the destination compute node 304.

Two possible paths of a packet vector 350 are depicted in FIG. 3. The packet vector 350 starts in RAM 316 of the first compute node 302. The transfer apparatus 102 determines that the packet vector has been processed by a last graph node 208 in the first compute node 302 (e.g., node 4 of FIG. 2) and is ready to be processed by a next graph node 208 (e.g., node 100 of FIG. 2) in the second compute node 304. The transfer apparatus 102 transmits the packet vector 350 to the second compute node 304. In some embodiments, the transfer apparatus 102 signals the RDMA controller 320 of the first compute node 302 to transfer the packet vector 350. The RDMA controller 320 of the first compute node 302 engages the RDMA controller 320 of the second compute node 304 transmits the packet vector 350 through the NIC 324 of the first compute node 302 and the NIC 324 of the second compute node 304 to either RAM 316 of the second compute node 304 or to level 3 cache 315 of the second compute node 304.

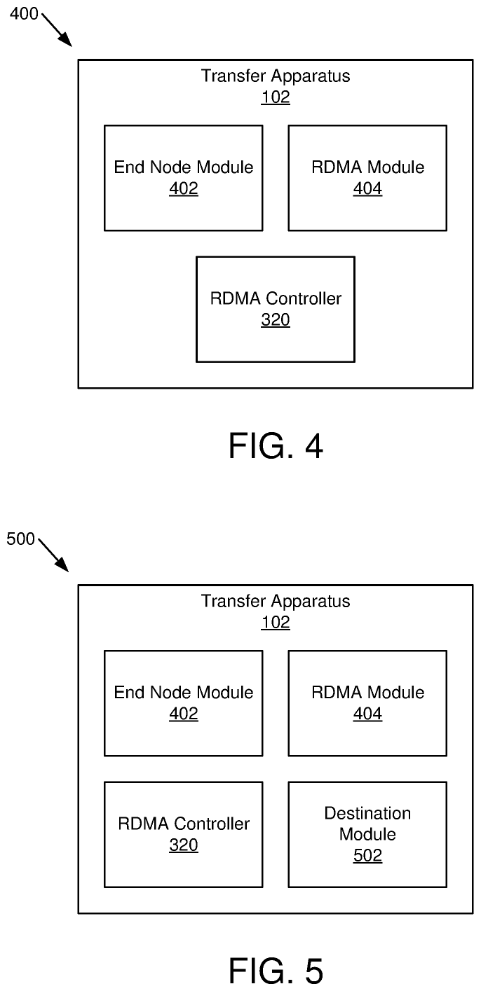

FIG. 4 is a schematic block diagram illustrating an apparatus 400 for transferring data between compute nodes running a distributed packet processing graph, according to various embodiments. The apparatus 400 includes a transfer apparatus 102 with an end node module 402, an RDMA module 404, and an RDMA controller 320, which are described below. In some embodiments, all or a portion of the apparatus 400 is implemented with code stored on computer readable storage media, such as RAM 316 and/or non-volatile storage 322 of a compute node 104, 106, 202, 204, 302, 304. In other embodiments, all or a portion of the apparatus 400 is implemented with a programmable hardware device and/or hardware circuits.

The apparatus 400 includes an end node module 402 configured to determine that a packet vector 350 processed by a previous graph node 208 (e.g., node 4) in a first compute node 104, 106, 202, 302 is ready to be processed by a next graph node 208 (e.g., node 100) in a second compute node 104, 106, 204, 304. The packet vector 350 includes two or more data packets. Typically, packet vectors 350 are formed at a beginning of a packet processing graph from sequentially received packets that are formed into a packet vector 350. In some embodiments, a packet vector 350 is chosen to be a convenient size, such as to fit in a maximum frame size. In other embodiments, packet vectors 350 include a particular number of data packets, such as 10 data packets. In other embodiments, a packet vector 350 is chosen based on processing size limits of graph nodes 208 of a packet processing graph. One of skill in the art will recognize other ways to size a packet vector 350.

The previous and next graph nodes 208 include graph nodes 208 of a packet processing graph implemented as a directed acyclic graph (“DAG”) that extends across the first and second compute nodes 104, 106, 202, 204, 302, 304. (Note that as used herein, compute nodes 104, 106 of FIG. 1 may also include the compute nodes 202, 204, 302 and 304 of FIGS. 2 and 3. Likewise, referring to any of the compute nodes 202, 204, 302, 304 in FIGS. 2 and 3 may also refer to the compute nodes 104, 106 of FIG. 1.) The packet processing graph may be any packet processing graph that extends across more than one compute node 104, 106, 202, 204, 302, 304. The packet processing graph processes data packets received at a first compute node (e.g., 202, 302) of compute nodes 104, 106, 202, 204, 302, 304 upon which the packet processing graph is implemented. In other embodiments, the packet processing graph includes other functions in addition to packet processing.

In some embodiments, the first and second compute nodes 104, 106 each run an instance of a vector packet processor. The vector packet processor is described above. In some embodiments, the vector packet processor is an FD.io® vector packet processor and may include various versions and implementations of VPP. FD.io VPP is an open source project. In other embodiments, the vector packet processor is from a particular vendor.

In some embodiments, the apparatus 400 is implemented as a plugin graph node at the end of a string of graph nodes 208 in a first compute node (e.g., 202, 302) and receives a packet vector 350. In the example of FIG. 2, the transfer apparatus 102 is positioned after node 4. The end node module 402 is configured, in some embodiments, to receive a packet vector 350 in anticipation of transmitting the packet vector 350 to the second compute node 204, 304.

The apparatus 400 includes an RDMA module 404 configured to transmit the packet vector 350 from the first compute node 202, 302 to the second compute node 204, 304 using RDMA. In some embodiments, the RDMA module 404 commands an RDMA controller 320 to send the packet vector 350 using RDMA. In some embodiments, the RDMA module 404 provides information about the packet vector 350, such as a memory location, a length of the packet vector 350, a location of metadata, information about a next graph node 208 (e.g., node 100) of the second compute node 204, 304, and the like to the RDMA controller 320. In other embodiments, the RDMA module 404 is included in an RDMA controller 320 and controls each aspect of the RDMA process. One of skill in the art will recognize other implementations and features of the RDMA module 404.

In some embodiments, the packet vector 350 includes metadata and the RDMA module 404 is configured to transmit the metadata of the packet vector 350 to the second compute node 204, 304 with other data of the packet vector 350. The metadata, in some embodiments, is related to the packet processing graph and is useful within the second compute node 204, 304.

In some embodiments, the RDMA module 404 is configured to transmit the packet vector 350 from memory, such as RAM 316, of the first compute node 202, 302 to memory, such as RAM 316, of the second compute node 204, 304. In other embodiments, the RDMA module 404 is configured to transmit the packet vector 350 from memory, such as RAM 316, of the first compute node 202, 302 to level 3 cache 314 of the second compute node 204, 304. In other embodiments, the RDMA module 404 is configured to transmit the packet vector 350 from level 3 cache 314 of the first compute node 202, 302 to level 3 cache 314 of the second compute node 204, 304. In other embodiments, the RDMA module 404 is configured to transmit the packet vector 350 from level 3 cache 314 of the first compute node 202, 302 to memory, such as RAM 316, of the second compute node 204, 304. In other embodiments, the RDMA module 404 is configured to transmit the packet vector 350 from memory of some type (e.g., RAM 316, level 3 cache 314, level 2 cache 312, level 1 cache 310) of the first compute node 202, 302 to some memory of some type (e.g., RAM 316, level 3 cache 314, level 2 cache 312, level 1 cache 310) of the second compute node 204, 304. The embodiments described herein contemplate any type of RDMA transfer from the first compute node 202, 302 to the second compute node 204, 304 that is available now or in the future.

FIG. 5 is a schematic block diagram illustrating another apparatus 500 for transferring data between compute nodes running a distributed packet processing graph, according to various embodiments. includes a transfer apparatus 102 with an end node module 402, an RDMA module 404, and an RDMA controller 320, which are substantially similar to those described above in relation to the apparatus 400 of FIG. 4. The apparatus 500 also includes a destination module 502, which is described below. In some embodiments, all or a portion of the apparatus 500 is implemented with code stored on computer readable storage media, such as RAM 316 and/or non-volatile storage 322 of a compute node 104, 106, 202, 204, 302, 304. In other embodiments, all or a portion of the apparatus 500 is implemented with a programmable hardware device and/or hardware circuits.

The destination module 502 is configured to, prior to transmitting the packet vector 350, communicate with the second compute node 204, 304 to determine a location for transfer of the packet vector 350 to the second compute node 204, 304. In some embodiments, the destination module 502 determines a location for transfer of the packet vector 350 based on a pointer location. In other embodiments, the destination module 502 determines a location for transfer of the packet vector 350 as a memory address. In other embodiments, the destination module 502 determines a location for transfer of the packet vector 350, such as RAM 316 or level 3 cache 314, based on requirements of the packet processing graph. One of skill in the art will recognize other ways for the destination module 502 to determine a destination for the packet vector 350.

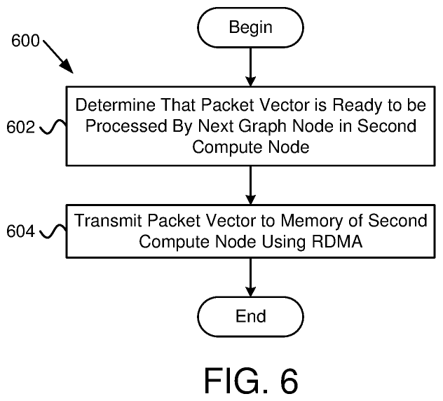

FIG. 6 is a schematic flow chart diagram illustrating a method 600 for transferring data between compute nodes running a distributed packet processing graph, according to various embodiments. The method 600 begins and determines 602 that a packet vector 350 processed by a previous graph node 208 (e.g., node 4) in a first compute node 202, 302 is ready to be processed by a next graph node 208 (e.g., node 100) in a second compute node 204, 304. The packet vector 350 includes a plurality of data packets. The previous and next graph nodes 208 are graph nodes 208 of a packet processing graph implemented as a DAG that extends across the first and second compute nodes 202, 204, 302, 304. The first and second compute nodes 202, 204, 302, 304 each run an instance of a vector packet processor. The method 600 transmits 604 the packet vector from the first compute node to the second compute node using RDMA, and the method 600 ends. In various embodiments, all or a portion of the method 600 is implemented with the end node module 402 and/or the RDMA module 404.

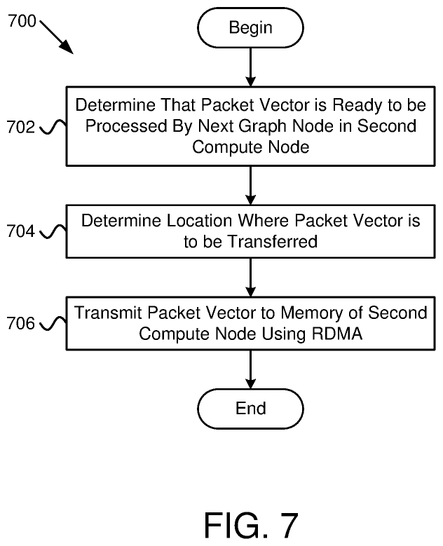

FIG. 7 is a schematic flow chart diagram illustrating another method 700 for transferring data between compute nodes running a distributed packet processing graph, according to various embodiments. The method 700 begins and determines 702 that a packet vector 350 processed by a previous graph node 208 (e.g., node 4) in a first compute node 202, 302 is ready to be processed by a next graph node 208 (e.g., node 100) in a second compute node 204, 304. The packet vector 350 includes a plurality of data packets. The previous and next graph nodes 208 are graph nodes 208 of a packet processing graph implemented as a DAG that extends across the first and second compute nodes 202, 204, 302, 304. The first and second compute nodes 202, 204, 302, 304 each run an instance of a vector packet processor.

The method 700 communicates 704 with the second compute node 204, 304 to determine a location for transfer of the packet vector 350 to the second compute node 204, 304 and transmits 706 the packet vector from the first compute node 202, 302 to the determined destination in the second compute node 204, 304 using RDMA, and the method 700 ends. In various embodiments, all or a portion of the method 600 is implemented with the end node module 402, the RDMA module 404, and or the destination module 502.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
determining that a packet vector processed by a previous graph node in a first compute node is ready to be processed by a next graph node in a second compute node, the packet vector comprising a plurality of data packets, the previous and next graph nodes comprising graph nodes of a packet processing graph implemented as a directed acyclic graph (“DAG”) that extends across the first and second compute nodes, the first and second compute nodes each running an instance of a vector packet processor; and
transmitting the packet vector from the first compute node to the second compute node using remote direct memory access (“RDMA”).

2. The method of claim 1, wherein the packet vector comprises metadata and the metadata is transferred to the second compute node along with data of the packet vector.

3. The method of claim 1, wherein the packet vector is transmitted from memory of the first compute node to memory of the second compute node.

4. The method of claim 3, wherein the memory of the second compute node comprises level three cache.

5. The method of claim 1, further comprising, prior to transmitting the packet vector, communicating with the second compute node to determine a location for transfer of the packet vector to the second compute node.

6. The method of claim 1, wherein the first compute node comprises a RDMA controller and wherein transmitting the packet vector is via the RDMA controller.

7. The method of claim 1, wherein graph nodes of the packet processing graph in the first compute node are implemented in a first virtual machine (“VM”) and wherein graph nodes of the packet processing graph in the second compute node are implemented in a second VM.

8. The method of claim 1, wherein the packet processing graph comprises a virtual router and/or a virtual switch.

9. The method of claim 1, wherein the first and second compute nodes comprise generic servers in a datacenter.

10. An apparatus comprising:
a first compute node comprising a first processor running an instance of a vector packet processor, the first compute node connected to a second compute node over a network, the second compute node comprising a second processor running another instance of the vector packet processor; and
non-transitory computer readable storage media storing code, the code being executable by the first processor to perform operations comprising:
determining that a packet vector processed by a previous graph node in the first compute node is ready to be processed by a next graph node in the second compute node, the packet vector comprising a plurality of data packets, the previous and next graph nodes comprising graph nodes of a packet processing graph implemented as a directed acyclic graph (“DAG”) that extends across the first and second compute nodes; and
transmitting the packet vector from the first compute node to the second compute node using remote direct memory access (“RDMA”).

11. The apparatus of claim 10, wherein the packet vector comprises metadata and the metadata is transferred to the second compute node along with data of the packet vector.

12. The apparatus of claim 10, wherein the packet vector is transmitted from memory of the first compute node to memory of the second compute node.

13. The apparatus of claim 12, wherein the memory of the second compute node comprises level three cache.

14. The apparatus of claim 10, wherein the operations further comprise, prior to transmitting the packet vector, communicating with the second compute node to determine a location for transfer of the packet vector to the second compute node.

15. The apparatus of claim 10, wherein the first compute node comprises a RDMA controller and wherein transmitting the packet vector is via the RDMA controller.

16. The apparatus of claim 10, wherein graph nodes of the packet processing graph in the first compute node are implemented in a first virtual machine (“VM”) and wherein graph nodes of the packet processing graph in the second compute node are implemented in a second VM.

17. The apparatus of claim 10, wherein the packet processing graph comprises a virtual router and/or a virtual switch.

18. The apparatus of claim 10, wherein the first and second compute nodes comprise generic servers in a datacenter.

19. A program product comprising a non-transitory computer readable storage medium storing code, the code being configured to be executable by a processor to perform operations comprising:
determining that a packet vector processed by a previous graph node in a first compute node is ready to be processed by a next graph node in a second compute node, the packet vector comprising a plurality of data packets, the previous and next graph nodes comprising graph nodes of a packet processing graph implemented as a directed acyclic graph (“DAG”) that extends across the first and second compute nodes, the first and second compute nodes each running an instance of a vector packet processor; and
transmitting the packet vector from the first compute node to the second compute node using remote direct memory access (“RDMA”).

20. The program product of claim 19, wherein the packet vector is transmitted from memory of the first compute node to level three cache of the second compute node.
